(19) United States
(12) Patent Application Publication
(10) Pub. No.: US 2026/0086529 A1
(43) Pub. Date: Mar. 26, 2026

(54) METHOD FOR MACHINING A CUTTING TOOL, AND MACHINING DEVICE FOR CARRYING OUT THE METHOD

(71) Applicant: Rollomatic S.A., Le Landeron (CH)

(72) Inventors: Christian KRUMM, Cortébert (CH); Mouhamad Ali FREIDY, Neuchâtel (CH)

(73) Assignee: Rollomatic S.A., Le Landeron (CH)

(21) Appl. No.: 19/109,699

(22) PCT Filed: Sep. 11, 2023
(86) PCT No.: PCT/EP2023/074932

§ 371 Date: Mar. 7, 2025

(30) Foreign Application Priority Data
Sep. 12, 2022 (EP) 22195239.3

(51) Int. Cl. G05B 19/401

(52) U.S. Cl. CPC G05B 19/401; G05B 2219/37227; G05B 2219/37575; G05B 2219/45159

(57) ABSTRACT

In a method for machining a cutting tool and a machining device for carrying out the method, the cutting tool includes a cutting tool body and at least one cutting insert with at least one cutting edge attached to the cutting tool body. A three-dimensional surface of the cutting tool is predetermined. Cutting edge boundary surfaces are determined from this surface, which form a surface of the cutting insert and are located adjacent to a cutting edge of the cutting insert. The machining device is controlled on the basis of these cutting edge boundary surfaces and removes material from the cutting insert in a targeted manner, whereby a collision between the cutting tool and a material removal device of the machining device is prevented.

The invention relates to a method for machining a cutting tool comprising a cutting tool body and at least one cutting insert with at least one cutting edge attached to the cutting tool body.

Cutting tools include machining tools for chip removing manufacturing processes and tools for dividing. They usually have a shaft and a cutting part. The shaft is used to hold the cutting tool, for example in a machine interface for machine cutting tools. The shaft is provided with the cutting part. The cutting part includes at least one cutting edge for the cutting tool to interact with a workpiece to remove material from the workpiece. Examples of such cutting tools are milling cutters, drills, reamers, chisels, scrapers, planers and saws. The cutting tool can be a solid tool made entirely from a single material. Alternatively, the cutting part may have a cutting insert that surrounds the cutting edge, where the cutting insert is made of a different material to the shaft. Cutting tools are subject to considerable mechanical and thermal stresses in the field due to the forces and temperatures they are subjected to. These include mechanical friction, oxidation and abrasion, as well as diffusion and scaling, especially at high cutting speeds. This leads to wear of the cutting tool at the cutting edge.

To improve the wear resistance of cutting tools and increase tool life, cutting tools are provided with a material in the area of the cutting edge that is harder than the rest of the cutting tool body. For a cutting tool with a cutting insert, either the cutting insert can be provided with a hard coating or the entire cutting insert can be made of a hard material. Such hard or ultra-hard materials include diamond, such as polycrystalline diamond PCD, single crystal diamond, crystalline diamond or diamond from chemical vapour deposition CVD, amorphous carbon known as diamond-like carbon DLC, cubic boron nitride CBN, titanium or ceramics. If the cutting insert has a hard material coating, this can be applied to the cutting insert by chemical vapour deposition (CVD), for example.

Cutting inserts are usually soldered directly onto the cutting tool body. Although this connection is very strong, soldering is not precise enough to ensure the exact positioning of the cutting inserts on the cutting tool body. In addition, the cutting inserts may have certain inaccuracies in shape, length, width, depth or curvature of their surfaces. These inaccuracies of the cutting inserts and inaccurate positioning of the cutting inserts on the cutting tool body will result in the associated cutting tool not meeting the specified tolerances and being of poor quality. Therefore, a cutting tool has to be reworked after the cutting inserts have been soldered on. Reworking is the process of deliberately removing material from the cutting inserts so that in particular, the cutting edge and the surfaces bounded by the cutting edge meet the specifications. This is done using a machining device that has a fixing device that holds and fixes the cutting tool, a material removal device that removes material from the cutting tool, and a movement device. The movement device moves the cutting tool held in the fixing device and the material removal device relative to each other for targeted material removal. The material removal device may be provided with, for example, an abrasive disc, a laser for generating a laser beam, or an electrical discharge machine (EDM).

Before the cutting inserts soldered onto the tool body can be reworked with the machining device, the exact position of each cutting insert must be determined in three dimensions in relation to the known references of the cutting tool. It is also necessary to determine whether the surfaces are flat or curved. For example, if the cutting tool is a rotary tool that rotates about a geometric axis of rotation of the cutting tool in use, the cutting tool geometric axis of rotation can be, for example, a reference point. Another reference point can be a top face of the cutting tool or a bottom face of the cutting tool.

From the detected position, alignment and shape of the cutting inserts the path along which the material removal device must be moved relative to the cutting tool is determined in order to achieve the necessary material removal required to finish the cutting insert for the reworking.

It is well known that the position of soldered cutting inserts on a cutting tool can be detected using a mechanical probe. The probe is mounted on the machining device. Depending on the type and shape of the cutting tool and the type and number of cutting inserts on the cutting tool, the probe must be moved relative to the cutting tool in such a way that it measures the position of the surface relative to a reference point, such as the geometric cutting tool axis of rotation at a minimum of three measuring point on each cutting insert. The probe is usually controlled by a computer, for example a CNC. The software must be written and specified by the responsible person based on the type, number and approximate position of the cutting inserts. The responsible person can use technical specifications and drawings of the cutting tool as a basis, but these specifications do not take into account the inaccuracies caused by the soldering of the cutting inserts. The responsible person must therefore enter the details into the control system so that the probe can be moved to the measuring points on the cutting inserts. This is particularly time consuming for cutting tools with a large number of cutting inserts. There is also a risk of making mistakes when entering the details into the control system.

The object of the invention is to provide a method to facilitate reworking of cutting inserts after soldering onto a cutting tool, whereby the reworking is carried out automatically and collision of the machining device with the cutting tool is avoided.

This object is solved by a method according to claim 1 and by a machining device according to claim 22. The method is characterised by the following method steps:
a) specifying target data for the cutting edge, which is referred to as the cutting edge target data. These comprise data for at least one of the following properties of the cutting edge: cutting edge position relative to a cutting tool based coordinate system, cutting edge geometry, cutting edge contour relative to the cutting edge based coordinate system. The cutting tool based coordinate system includes coordinate axes that pass through the cutting tool and a zero point in or on the cutting tool. When the cutting tool moves, the cutting tool based coordinate system moves with it. Therefore, the coordinates of the cutting edge position and the coordinates of the cutting edge direction do not change in this cutting tool bound coordinate system. The cutting edge target data define the details that the cutting edge of the cutting insert attached to the cutting tool must have and that are to be achieved by machining, unless the cutting edge already fulfils the relevant details.
b) specifying geometric material removal device data, including the shape and size of the material removal device. The dimensions of the material removal device are taken into account in the machining process.
c) fixing the cutting tool in the fixing device.
d) defining a three-dimensional surface of the cutting tool arranged in the fixing device of the machining device at least in those portions of the cutting tool that comprise the cutting insert and form an outer surface of the cutting tool. This surface is defined as the three-dimensional cutting tool surface.
e) determining those subregions of the three-dimensional cutting tool surface, that form a surface of the cutting insert and are located adjacent to the cutting edge. These surfaces are defined as cutting edge boundary surfaces. The cutting insert has at least two cutting edge boundary surfaces. These may be, for example, a flank face and a rake face of the cutting edge of the cutting insert.
f) determining cutting edge real data from the cutting edge boundary surfaces, whereby the cutting edge real data includes at least the property contained in the cutting edge target data. While the cutting edge target data describes the nominal state of the cutting edge, the cutting edge real data concerns the actual state of the cutting edge. In order to compare the actual state with the nominal state, the cutting edge real data contains details of the same properties as the cutting edge target data.
g) comparing the cutting edge real data with the cutting edge target data. It is determined whether the cutting edge real data matches the cutting edge target data. A predetermined tolerance is taken into account. If a match is found, the cutting edge does not need to be machined.
h) if the deviation between the cutting edge real data and the cutting edge target data is greater than a predetermined tolerance, the cutting insert is machined as follows:
i) determining a movement path of the movement device from the predefined material removal device data and the difference between the cutting edge real data and the cutting edge target data, such that, in the event of a relative movement of the cutting tool and the material removal device and simultaneous material removal at the cutting tool with the material removal device, the cutting edge is formed with the cutting edge target data within the specified tolerance and a collision between the cutting tool and the material removal device is avoided. This is done by processing the difference between the cutting edge real data and the cutting edge target data and the material removal device data. The movement path is used to determine how the material removal device must move relative to the cutting edge boundary surfaces so that the material removal device specifically removes material from the cutting insert so that the cutting tool, after machining, meets the specified parameters with the cutting edge target data.
j) controlling the material removal device and the movement device and removing material from the cutting insert. In the process, material is selectively removed from the cutting insert so that, after the material removal is complete, the cutting insert meets the cutting insert target data within predetermined tolerances and the machining device does not contact the cutting tool in an undesirable manner.

In principle, the cutting insert does not only have surfaces that are part of the cutting tool surface and are located adjacent to the cutting edge of the cutting insert. For example, the cutting insert also includes those surfaces where the cutting insert is soldered to the cutting tool body. It is assumed that those surfaces of the cutting insert that are part of the cutting tool surface and that are adjacent to the cutting edge of the cutting insert are particularly important to the quality of the cutting tool and therefore inspection and reworking in this area is particularly important. If necessary, reworking can also be carried out on surfaces of the cutting insert that are not adjacent to the cutting edge. Generally, no reworking is carried out in those areas of the cutting insert where the cutting insert is soldered to the cutting tool body, since these areas are not exposed and therefore do not directly affect the properties of the cutting edge, and because reworking these areas could cause the cutting insert become detached from the cutting tool body. In addition to these mounting areas and the surfaces that define the cutting edge, the cutting insert may have other surfaces that can be machined.

The three-dimensional cutting tool surface is specified in such a way that no data needs to be entered manually into the machining device. For example, the three-dimensional cutting tool surface can be generated from previously known CAD data of the cutting tool and entered into the machining device. This CAD data can contain the cutting tool surface in two or three dimensions. For example, the surface of the cutting tool body can be specified in three dimensions and the surface of the cutting insert can be specified in two dimensions. The three-dimensional surface of the cutting tool is then determined from this data. In this case, the three-dimensional surface of the cutting tool corresponds to, or is part of, the theoretical geometric surface of the cutting tool generated from the CAD design of the cutting tool. Alternatively, the three-dimensional surface can be generated using a surface scanner based on the cutting tool clamped in the fixing device and entered into the fixing device. In this case, the three-dimensional cutting tool surface is the actual surface of the cutting tool after the cutting inserts have been soldered. In both cases, there is no need to manually enter the surface data into the system. The process is therefore much less laborious and error-prone for the user.

By analyzing the three-dimensional cutting tool surface, the subregions that form a surface of the cutting insert and are located adjacent to a cutting edge are determined. These subregions are characterised by the fact that they have a certain alignment relative to a reference value of the cutting tool, for example the geometric cutting tool axis of rotation, the bottom side or the top side of the cutting tool. This property of the surfaces of the cutting inserts is used in their determination. The method according to the invention determines the cutting edge boundary surfaces regardless of how and in what way the three-dimensional cutting tool surface is specified. No data or information needs to be entered by the user for this purpose.

By analyzing the three-dimensional cutting tool surface and determining the cutting edge boundary surfaces from this, the position, alignment, possible curvature of the surface and the length, width or depth of the cutting inserts can be determined. If necessary and desired, measuring points can be defined on the cutting edge boundary surfaces at which the surface of the cutting inserts is scanned.

The cutting edge boundary surfaces determined from the three-dimensional cutting tool surface are adapted to the data obtained from the scanning. The cutting edge boundary surfaces, if necessary with the adjustment using data from the scanning, are used to determine for example how a material removal device must be moved relative to the cutting tool in order to remove material from the cutting inserts in a desired manner so that the soldered-on cutting inserts are reworked and the cutting tool meets the specifications for the position, alignment and path of the cutting edge and the surfaces bounded by the cutting edge within certain tolerances.

When determining the movement path, the geometry and dimensions of the removal device and the cutting tool are taken into account so that the relative movement of the removal device and the cutting tool is collision free.

The following surfaces can be associated with the cutting tool
1. a theoretical three-dimensional geometric surface of the cutting tool resulting from its design; if the cutting tool is designed using CAD, the theoretical three-dimensional geometric surface of the cutting tool can be derived from the CAD data. This surface may not include the inaccuracies resulting from the manufacture of the cutting insert and the soldering of the cutting insert.
2. the actual three-dimensional surface of the cutting tool after soldering of the cutting insert; this surface includes the inaccuracies resulting from the manufacture of the cutting insert and the soldering of the cutting insert; this surface can be determined, for example, by a surface scanner that scans the entire surface of the cutting tool; Alternatively, this surface can be determined using the data from section 1 and a subsequent scanning of the surfaces of the cutting insert at individual measuring points on the surface of the cutting insert, whereby the surface resulting from section 1 is adapted to the surface data resulting from the scanning at the measuring points; the number of measuring points in this case is considerably smaller than the number of points at which the surface of the cutting tool is measured by a surface scanner; it is also possible to adapt the surface determined by the surface scanner to the data obtained from the scanning of the measuring points; this can increase the accuracy if necessary. The three-dimensional cutting tool surface according to claim 1 can be derived from the theoretical three-dimensional surface according to FIG. 1 or from the actual three-dimensional surface according to FIG. 2.
3. Cutting edge boundary surfaces determined from the three-dimensional cutting tool surface:
   The cutting edge boundary surfaces can be determined from the theoretical geometric three-dimensional surface of the cutting tool according to section 1 above or from the actual three-dimensional surface of the cutting tool after soldering on the cutting insert according to section 2 above. If the cutting edge boundary surfaces are determined from the theoretical geometric three-dimensional surface of the cutting tool in accordance with section 1 above, several measuring points should be determined in the cutting edge boundary surfaces derived from these and the surface of the cutting tool placed in the fixing device should be detected at these measuring points by a measuring probe. This serves to adapt the theoretical cutting edge boundary surfaces to reality. The cutting edge boundary surfaces are adapted so that the scanning data recorded with the probe lie on the cutting edge boundary surfaces. These cutting edge boundary surfaces represent the real cutting edge data.
4. Reworked cutting edge boundary surfaces: After the material removal process of the invention has been carried out, the cutting edges and the adjacent cutting edge boundary surfaces of the cutting tool should meet the specifications applicable to the cutting edge and the cutting edge boundary surfaces within predetermined tolerances. In this case, the cutting edge has the cutting edge target data.

In the method according to the invention, the three-dimensional cutting tool surface is specified according to section 1 above or section 2 above, and the cutting edge boundary surfaces are determined therefrom according with section above. It is assumed that these cutting edge boundary surfaces correspond to the corresponding real surfaces on the cutting tool clamped in the fixing device and to be machined, and that the cutting edges have real data. The movement device and the material removal device are controlled based on these cutting edge boundary surfaces so that material is selectively removed from the cutting insert. The object for the reworked cutting edge boundary surfaces is to meet the criteria given in section 4 above and the cutting edge target data after machining is complete. If the cutting edge boundary surfaces meet the criteria, then the cutting edge also meets the specified criteria.

The data required for reworking is automatically determined from the cutting tool surface, without the need for manual input or measurement by the user. This considerably simplifies the reworking process. As no input errors can occur, the reworking is also more accurate.

Before soldering to the cutting tool body, the cutting insert can be sized to ensure that there is always enough material available to form a cutting edge with the specified criteria on the cutting tool if material removal is required. In this case, the cutting insert protrudes beyond the cutting tool body and a specified cutting tool geometry. If necessary, the cutting edge is formed only when the method according to the invention is carried out on the cutting tool.

In order to avoid undesired collisions between the material removal device and the cutting tool, the geometric data of the material removal device, which includes the shape and size of the material removal device, is taken into account when determining the movement path. This can be done using known collision avoidance calculation methods. In this case, the specified data of the cutting tool and the material removal device are taken into account. Known collision avoidance calculation methods can be used. For example, a Minkowski addition is used for this purpose.

According to an advantageous embodiment of the invention, the cutting edge boundary surfaces are used to determine where and how much material has to be removed from the cutting insert so that the cutting insert fulfils predetermined parameters in the area of its cutting edge, taking into account predetermined tolerances. The movement device and/or the material removal device are controlled in such a way that the material removal device removes this material. The parameters include, for example, the alignment and/or position and/or size and/or curvature of the cutting edge boundary surfaces. Nominal values and tolerances may be specified for this purpose.

According to a further advantageous embodiment of the invention, the cutting tool is a rotary cutting tool which, is rotated about a geometric cutting tool axis of rotation during its use. The geometric cutting tool axis of rotation corresponds to the axis about which the cutting tool is rotated at its subsequent point of use. Advantageously, the cutting tool, which is designed as a rotary tool, is received in the fixing device in such a way that it is rotated about the geometric cutting tool axis of rotation by the movement device.

According to a further advantageous embodiment of the invention, the alignment of the cutting edge boundary surfaces relative to the geometric cutting tool axis of rotation is determined. This takes advantage of the fact that cutting inserts usually have a certain alignment relative to the geometric cutting tool axis of rotation. This alignment is a prerequisite for the cutting inserts to achieve the desired material removal at the subsequent point of application of the cutting tool when the cutting tool is rotated about the cutting tool axis of rotation.

According to a further advantageous embodiment of the invention, the position of the cutting edge boundary surfaces relative to the geometric cutting tool axis of rotation is determined. This takes advantage of the fact that the cutting inserts usually have a certain position relative to the geometric cutting tool axis of rotation.

According to a further advantageous embodiment of the invention, the position of the cutting edge boundary surface relative to an end face of the cutting tool is determined. When the cutting tool is configured as a rotary tool that is rotated about a cutting tool axis of rotation at the point of use and that extends along the cutting tool axis of rotation from a first end to a second end, the end face is preferably a surface of the cutting tool that is perpendicular to the cutting tool axis of rotation at the first end or at the second end.

According to a further advantageous embodiment of the invention, a plurality of measuring points are determined on at least one cutting edge boundary surface. At these measuring points, the coordinates corresponding to the cutting edge boundary surface, referred to a predetermined coordinate system, are determined by a coordinate measuring device. The coordinate measuring device can be, for example, a touch probe. The coordinate measuring device can measure the coordinates of the cutting edge boundary surface associated with the measuring points either in a contact or in a non-contact manner. The determination of the measuring points takes advantage of the fact that the cutting edge boundary surface is derived from the three-dimensional cutting tool surface and the measuring points for scanning can be determined automatically from the cutting tool surface without user intervention. A relative movement between the coordinate measuring device and the cutting tool can be carried out using the movement device of the machining device. The relative movement is such that the coordinate measuring device measures the coordinates of the cutting edge boundary surface at the specified measuring points without the coordinate measuring device touching or colliding with the cutting tool in an undesirable manner. The coordinate measuring device can be designed as a mechanical probe and can detect the surface of the cutting inserts at the measuring points by touching them. Alternatively, the coordinate measuring device can determine the coordinates without touching them. In this case, the surface at the measuring points can be detected optically, for example. At least three measuring points are determined for each cutting insert. In contrast to the surface scanner, the coordinate measuring device only measures the surface of the cutting tool at a small number of measuring points on at least one cutting edge boundary surface. The coordinate measuring device is not necessarily used to measure the entire surface of the cutting tool, as is the case with the surface scanner.

According to a further advantageous embodiment of the invention, the cutting edge boundary surface is adapted taking into account the detected coordinates of the measuring points on the cutting edge boundary surface such that these coordinates lie on the adapted cutting edge boundary surface. The coordinates are part of the adapted cutting edge boundary surface. In this way the cutting edge boundary surfaces can be corrected. For example, the three-dimensional cutting tool surface determined from CAD data or from a surface scan can be modified so that the scanned data lies on the three-dimensional cutting tool surface. In this way, inaccuracies or deviations from the real surface are taken into account.

According to a further advantageous embodiment of the invention, the recorded coordinates of the measuring points are used to check whether the cutting edge boundary surfaces are curved or flat. For example, if it is determined that one of the cutting edge boundary surfaces has a curvature that results in an undesirable curvature of the cutting edge, the corresponding cutting edge boundary surface can be smoothed by reworking and converted to a flat surface so that the cutting edge has a predetermined straight course. If the cutting edge boundary surfaces have a curvature according to the specification, more than three measuring points shall be specified. If the cutting edge also has a curvature according to the specification, the movement device and/or the material removal device shall be controlled accordingly so that the cutting edge meets the curvature specifications after reworking.

According to a further advantageous embodiment of the invention, the coordinate measuring device is moved relative to the cutting tool with the movement device in such a way that the coordinates of the measuring points are detected and the relative movement is carried out without collisions between the cutting tool and the coordinate measuring device.

In a further advantageous embodiment of the invention, the movement path extends in a region that extends beyond an edge of at least one cutting edge boundary surface. This ensures that the material removal device machines the entire cutting edge boundary surface.

According to another advantageous embodiment of the invention, a starting point and an end point of material removal at the cutting edge boundary surfaces are determined with the aid on the cutting edge boundary surfaces. At the starting point, machining of the cutting insert with the material removing device is started. Machining of the insert is completed at the end point. The start point and end point are two spatially defined points on the cutting edge boundary surfaces. Between the start point and the end point there is a progressive machining of the cutting edge boundary surface. Advantageously, the material removal device is guided along the movement path from the start point to the end point.

According to a further advantageous embodiment of the invention, the material removal device comprises a laser. A laser beam generated by the laser is intentionally directed onto the surface of the cutting insert. The laser beam generates such a high energy density at the surface of the cutting insert that the material of the cutting insert is locally vaporised or sublimated. This material removal is also known as laser ablation or laser vaporisation. The material can be removed in layers over a large area. The laser is pulsed, which is an advantage.

According to another advantageous embodiment of the invention, the laser is provided with an optical laser beam deflection device which, in addition to the movement device, moves the laser beam relative to the cutting tool. This makes it possible to generate two movements of the laser beam relative to the cutting tool: a first movement by the movement device and a second movement by the deflection device of the laser. The first and second movements are superimposed. In general, higher speeds can be achieved with the optical deflection device than with the movement device. The optical deflection device can be, for example, a laser scanner.

According to a further advantageous embodiment of the invention, the material removal device is provided with a abrasive wheel. In this case, the material removal is carried out by an abrasive process.

According to a further advantageous embodiment of the invention, the material removal device removes material by electrical discharge machining EDM.

According to a further advantageous embodiment of the invention, the cutting insert consists of an ultra-hard material such as polycrystalline diamond (PCD), cubic boron nitride (CBN), diamond from chemical vapour deposition (CVD), single crystal diamond or ceramic. In the case of a coating, this can be applied by CVD. Alternatively, diamond-like amorphous carbon (DLC) may be used.

According to a further advantageous embodiment of the invention, the three-dimensional cutting tool surface is determined from the given CAD data of the cutting tool. A geometric model of the cutting tool is available as a digital data set as a result of the computer aided design and manufacture of the cutting tool with at least one cutting insert. The CAD data contains this digital record. The theoretical geometric three-dimensional cutting tool surface can be calculated from the CAD data. As the CAD data is derived from the geometric model, it does not contain the inaccuracies caused by the manufacturing of the cutting inserts and the soldering of the cutting inserts to the cutting tool body. It is therefore not an exact representation of reality. For this reason, it may be advantageous to define measuring points on the surface of the cutting inserts, to capture the real cutting edge boundary surfaces by scanning at the measuring points with a probe, and to adapt the cutting edge boundary surfaces to the scan data.

According to a further advantageous embodiment of the invention, the three-dimensional cutting tool surface is generated by a surface scanner. The surface scanner is provided with one or more sensors which scan or measure the cutting tool in a systematic and regular manner. A large number of individual measurements are used to create an overall image of the cutting tool. The measurements taken by the sensors are converted into digital data and processed by a computer. The three-dimensional cutting tool surface can be calculated from this data. It may be that the three-dimensional cutting tool surface captured by the surface scanner is a very good representation of the real cutting tool surface. In this case it is not absolutely necessary to set up measuring points on the cutting insert surface and the surface is measured at these points with a probe. However, an additional scan with a probe can be carried out for control purposes. If, for example, during such a check on one surface of the cutting insert it is found that the scan data obtained with the probe is part of the three-dimensional cutting tool surface obtained with the surface scanner, then no further checks need be made on the remaining surfaces of the insert. If, on the other hand, deviations are found, the inspection can continue. This type of inspection using a touch probe is generally useful when the tool surface scanned by the surface scanner is not accurate enough.

According to another advantageous embodiment of the invention, a grid of partial surfaces is laid over the three-dimensional cutting tool surface. The alignment relative to a reference point, for example the geometric cutting tool axis of rotation, is determined for each partial surface. From this, the cutting edge boundary surfaces are determined.

According to another advantageous embodiment of the invention, the partial surfaces are triangles. Alternatively, the partial surfaces may also be rectangles or other polygons.

According to another advantageous embodiment of the invention, the alignment of each two adjacent partial surfaces is compared with each other. From this, the cutting edge boundary surfaces are determined. Use is made of the fact that adjacent partial surfaces which have the same or a similar alignment belong to the same cutting edge boundary surface.

According to another advantageous embodiment of the invention, the collision-free movement path is determined by a Minkowski addition. Alternatively, other calculation methods can be used to determine a collision-free movement path.

The machining device according to the invention is characterised in that it comprises a control device which controls the fixing device, the moving device and the material removal device in such a way that they carry out the method according to the invention.

According to another advantageous embodiment of the invention, the machining device is provided with a coordinate measuring device which is also controlled by the control device.

Further advantages and advantageous embodiments of the invention will be apparent from the following description, the drawing and the claims.

### DRAWING

The drawing shows embodiments of the subject matter of the invention. It shows

FIG. 1: Perspective view of a first embodiment of a cutting tool processed by the method according to the invention, representation based on CAD data,

FIG. 2: Perspective view of the cutting tool according to FIG. 1 based on data obtained using a surface scanner, represented by triangles.

FIG. 3: Representation according to FIG. 2 using different shades of grey,

FIG. 4: Perspective view of the cutting tool according to FIGS. 1, 2 and 3 after finishing by the method according to the invention,

FIG. 5: Representation of the cutting tool according to FIG. 1, with the outer cutting tool geometry marked,

FIG. 6: Representation of the cutting tool according to FIG. 1 with the movement path of a material removal device,

FIG. 7: Representation of the cutting tool according to FIG. 1 with marking of the measuring points at which the surface of a cutting insert is scanned with a measuring probe,

FIG. 8: Comparison of the CAD data and the data determined with the surface scanner for the cutting tool according to FIGS. 1 to 7,

FIG. 9: Perspective view of a second example of a cutting tool machined by the method according to the invention, representation based on CAD data,

FIG. 10: Perspective view of the cutting tool of FIG. 9 based on data obtained using a surface scanner,

FIG. 11: Detail of FIG. 9,

FIG. 12: Detail of FIG. 11,

FIG. 13: Part of the cutting tool according to FIGS. 9 and 10 after finishing by the method according to the invention,

FIG. 14: Machining device for carrying out the method.

### DESCRIPTION OF THE EMBODIMENTS

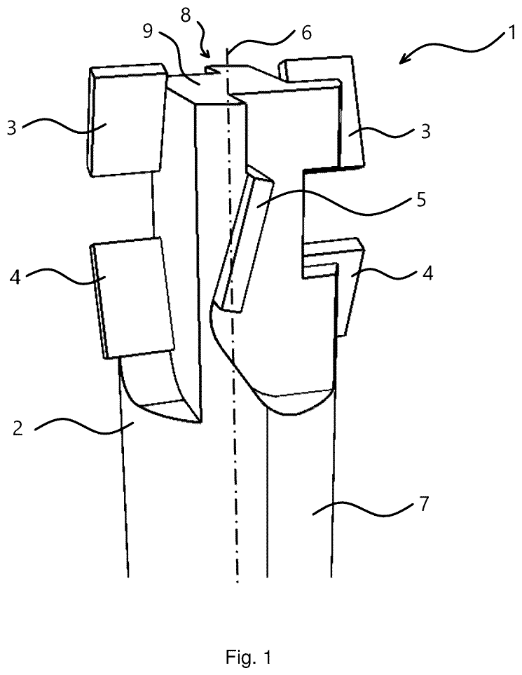

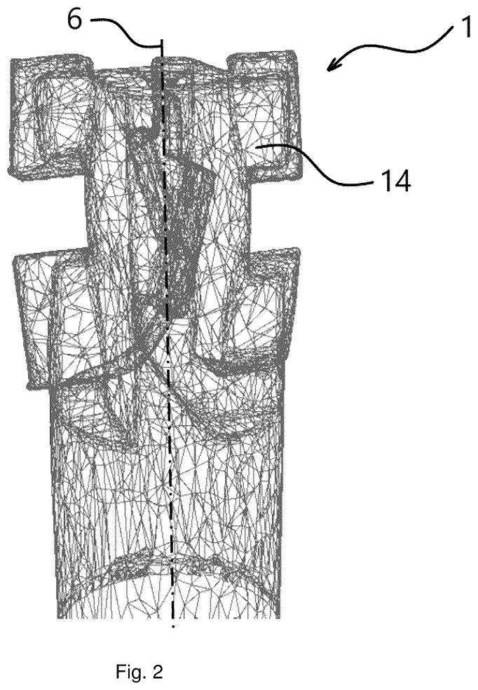

FIGS. 1 to 8 show a first cutting tool machined by the method according to the invention. The machining device used for the machining is shown in FIG. 14. FIGS. 1 and 2 show the cutting tool prior machining. FIG. 1 corresponds to a representation of the CAD data of the cutting tool as specified by the CAD design of the cutting tool. FIG. 2 corresponds to a representation of the data obtained using a surface scanner. The cutting tool 1 comprises a cutting tool body 2 on which a total of six cutting inserts 3, 4, 5 are arranged. The cutting tool is a rotary tool that is rotated at its point of use about a geometric cutting tool axis of rotation 6. The cutting tool is not shown in its entirety in the drawing. A shaft 7, which is used to hold the cutting tool 1 in a machine not shown, is only partially shown for reasons of clarity. There are no cutting inserts in the unshown part of the cutting tool. Therefore, no machining is carried out with the method in the non-represented part of the cutting tool. The section of the cutting tool 1 in which the cutting inserts 3, 4, 5 are arranged on the cutting tool body 2 is defined as the three-dimensional cutting tool surface. This three-dimensional cutting tool surface is visible at least in FIGS. 1 and 2 as far as it faces the viewer. The parts of the three-dimensional cutting tool surface facing away from the viewer are covered by the cutting tool body 2 in FIGS. 1 and 2.

The cutting inserts 3, 4, 5 are arranged offset in relation to the cutting tool axis of rotation. The first two cutting inserts 3 are located at one end 8 of the cutting tool. They are arranged offset by 180° relative to each other on the cutting tool body 2 and inclined by an angle α relative to the cutting tool axis of rotation. The two second cutting inserts 4 are arranged in the axial direction with respect to the cutting tool axis of rotation 6 at a distance from the end 8 and from the two first cutting inserts 3. They are mounted on the cutting tool body in the axial direction offset from the first cutting inserts 3. The angular distance between the two second cutting inserts is also 180°. The two third cutting inserts 5 are located between the two first and second cutting inserts 3, 4 in terms of their axial position and their angular position. In the drawing, only one of the two third cutting inserts 5 is visible, as the other third cutting insert 5 is hidden by the cutting tool body 2.

The first, second and third cutting inserts 3, 4, 5 are soldered to the cutting tool body 2. After soldering, the cutting inserts 3, 4, 5 initially protrude radially outwards beyond the cutting tool body 2. FIGS. 1 and 2 show the cutting tool after soldering of the cutting inserts 3, 4, 5. In particular, the portion of the first cutting inserts 3 and the second cutting inserts 4 projecting radially beyond the cutting tool body is clearly visible.

FIG. 1 shows a representation of the cutting tool 1 prior machining by the method, based on CAD data. This CAD data results from the computer aided design of the cutting tool. The 3-dimensional surface of the cutting tool is shown, which includes the cutting inserts 3, 4, 5.

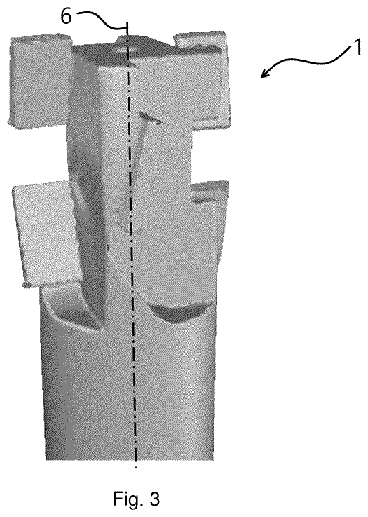

FIG. 2 shows a representation of the cutting tool 1 before machining by the method, the representation being based on data obtained using a surface scanner. This surface scanner is shown in FIG. 14 with reference number 59. The surface scanner is used to scan the surface of the cutting tool 1 from all sides in the areas where the cutting inserts 3, 4, 5 are located. The result is the three-dimensional surface of the cutting tool, which is essential for the process. As shown in FIG. 2, the surface of the cutting tool 1 has been scanned in exactly the same section of the cutting tool 1 as shown in FIG. 1 based on the CAD data. The surface scanner provides a set of surface points. These are connected by lines in FIG. 2 to form triangles. FIG. 3 shows an alternative representation based on the same set of surface points as FIG. 2, but instead of triangles, different shades of grey are shown. The shape of the cutting tool 1 is easier to see in this representation than in FIG. 2.

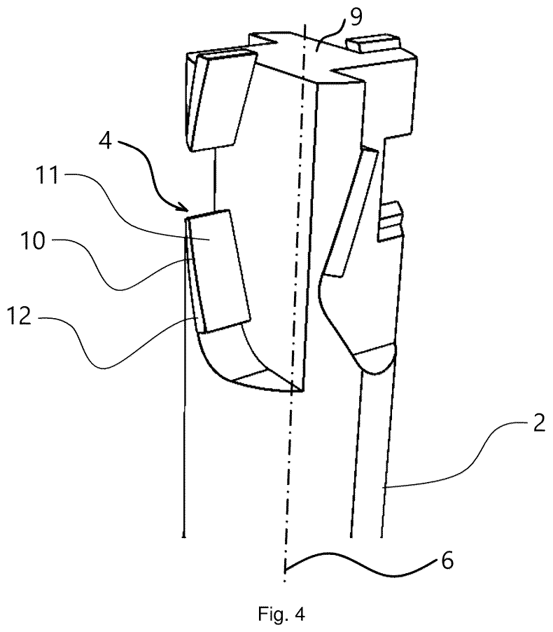

FIG. 4 shows the cutting tool 1 with the cutting inserts 3, 4, 5, whereby the cutting inserts fulfil predetermined criteria with respect to the position and course of their cutting edges 10. The cutting inserts 3, 4, 5 protrude significantly less radially outwards from the cutting tool body 2. As shown by the second cutting insert 4, the cutting edge 10 delimits a first cutting edge boundary surface 11 and a second cutting edge boundary surface 12. The same applies to the first cutting inserts 3 and the third cutting inserts 5.

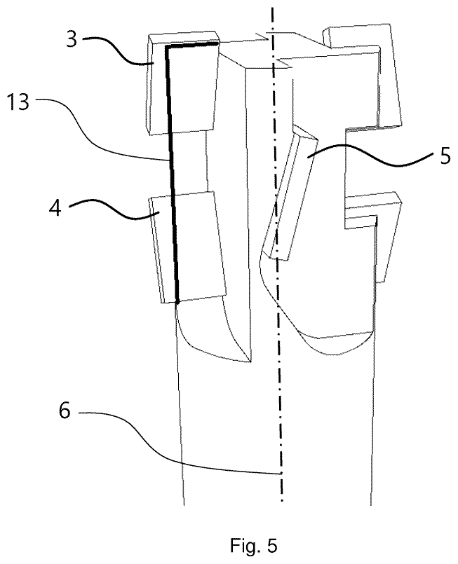

FIG. 5 shows the cutting tool 1 according to FIGS. 1 and 2, with the outer geometry 13 of the cutting tool, which is defined by the predetermined course of the cutting edges 10 of the cutting inserts 3, 4, 5, which is marked by a line in the area of the first cutting insert 3 and the second cutting insert. It is clear from this representation that the area of the cutting inserts 3, 4, 5 which protrudes beyond the outer geometry 13 of the cutting tool 1 must be removed. In particular, a first cutting edge defining surface 11a and/or a second cutting edge boundary surface 12a must be reworked so that they correspond within tolerances with the first cutting edge boundary surface 11 and the second cutting edge boundary surface 12 according to FIG. 4 and the cutting edge 10 thus has the predetermined shape.

In order to enable the cutting inserts 3, 4, 5 to be machined in the region of the cutting edge boundary surfaces 11a, 12a, the three-dimensional surface of the cutting tool 1 is determined on the basis of the CAD data according to FIG. 1 or on the basis of the data determined by the surface scanner according to FIG. 2. The totality of these given data is referred to as the three-dimensional cutting tool surface. From this three-dimensional cutting tool surface, those subregions are determined which form a surface of a cutting insert 3, 4, 5 and are arranged adjacent to a cutting edge. These are referred to as cutting edge boundary surfaces 11a, 12a. They are determined by comparing the alignment or position of the surfaces with the cutting tool axis of rotation 6 or an end face 9 of the cutting tool. For this purpose, the three-dimensional cutting tool surface is divided into a grid of partial surfaces 14. In the representation according to FIG. 2, the grid with the partial surfaces 14 corresponds to the triangles resulting from the connection of the surface points. For each partial surface 14, the alignment relative to the geometric cutting tool axis of rotation 6 is determined. Alternatively or cumulatively, the alignment relative to the end face 9 of the cutting tool can also be determined for each partial surface 14. Partial surfaces 14 having the same alignment are assigned to a common surface. The cutting edge boundary surfaces 11a, 12a differ from other surfaces of the cutting tool 1 in that they have a very specific predetermined alignment relative to the cutting tool axis of rotation 6 or to the end face 9.

The cutting edge real data is determined from the cutting edge boundary surfaces. It relates to at least one property of the cutting edge, namely the cutting edge position relative to a cutting tool based coordinate system, the cutting edge geometry or the cutting edge contour relative to the cutting edge based coordinate system.

Cutting edge target data are specified for the cutting tool, which relate to the corresponding property from the set of properties mentioned above: cutting edge position relative to a cutting tool based coordinate system, cutting edge geometry, cutting edge contour relative to the cutting edge based coordinate system. The cutting tool shown in FIG. 4 has these cutting edge target data.

The cutting edge real data is compared with the cutting edge target data. This comparison indicates whether and how much material must be removed from the defined cutting edge boundary surfaces 11a, 12a so that the cutting edge 10 has the cutting edge target data and the specified contour with the specified outer geometry 13.

Material removal device data is specified for the machining device 50 according to FIG. 14, which includes the shape and size of the material removal device 56.

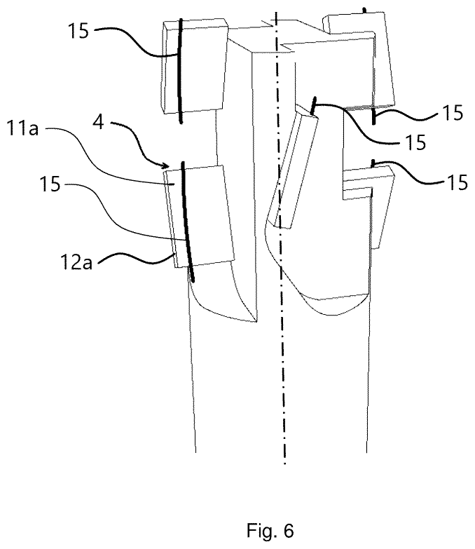

The movement path 15 of a material removal device is determined by comparing the actual cutting edge data with the cutting edge target data and the material removal device data. In FIG. 6, this movement path 15 is shown for the first, second and third cutting inserts 3, 4, 5. The movement path 15 extends beyond the cutting edge boundary surfaces 11a, 12a to ensure that the entire cutting edge surface 11a, 12a is machined. The movement path is predetermined such that the required amount of material is removed from the cutting insert without the material removal device colliding with the cutting tool.

In the present embodiment, the processing machine is a laser processing machine as shown in FIG. 14. The material removal device in this case is a laser. A laser beam from the laser is directed onto the first cutting edge boundary surface 11a and material is removed. To do this, the laser beam is guided once or several times along the movement path 15 until the two cutting edge surfaces 11, 12 and the cutting edge 13 are produced as shown in FIG. 4. Alternatively, the material removal can also start from the second cutting edge boundary surface 12a. In this case, the movement path can be different from that shown in FIG. 6.

If the three-dimensional cutting tool surface resulting from the CAD data according to FIG. 1 does not sufficiently represent reality, or if a check of the three-dimensional cutting tool surface according to FIG. 1, 2 or 3 is desired, measuring points can be determined on at least one cutting edge boundary surface 11a, at which the coordinates of the cutting edge boundary surface are determined by a coordinate measuring device. In the present case, three measuring points 16 are determined on the first cutting edge boundary surface 11a. The coordinates of the cutting edge boundary surface are then determined at these three measuring points 16 by an optical or mechanical coordinate measuring device. The measured data obtained at these measuring points 16 are compared with the cutting edge boundary surface 11a. In the event of a deviation, the cutting edge boundary surface 11a is corrected and adjusted accordingly so that the coordinates of the measuring points lie on the cutting edge boundary surface 11a. Such a check of the cutting edge boundary surfaces 11a, 12a can also be carried out if the three-dimensional cutting tool surface is determined by a surface scanner according to FIG. 2 or 3. Since the surface scanner already detects the surface of the real cutting tool, it is assumed that in this case a check is only necessary in exceptional cases or for control purposes. The coordinate measuring device is shown in FIG. 14 with reference number 60.

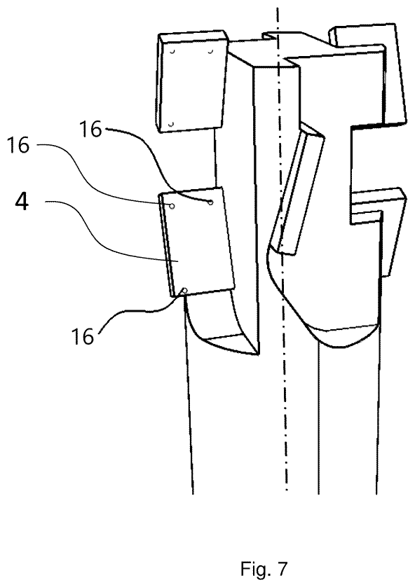

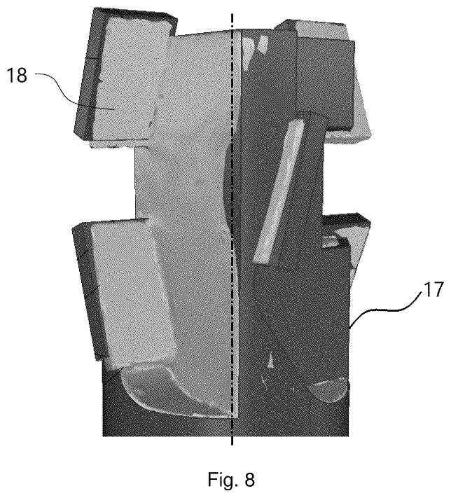

FIG. 8 shows a comparison of the three-dimensional cutting tool surface 17 determined using CAD data with the three-dimensional cutting tool surface 18 determined using a surface scanner. In the light grey areas, the three-dimensional cutting tool surface 18 determined by the surface scanner protrudes above the three-dimensional cutting tool surface 17 determined by the CAD data. In the dark grey areas, the opposite is true.

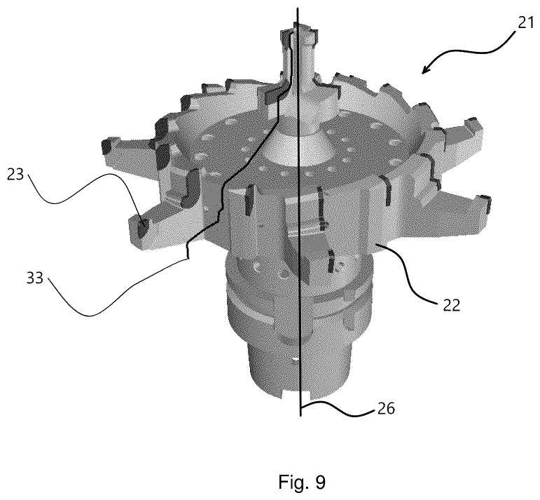

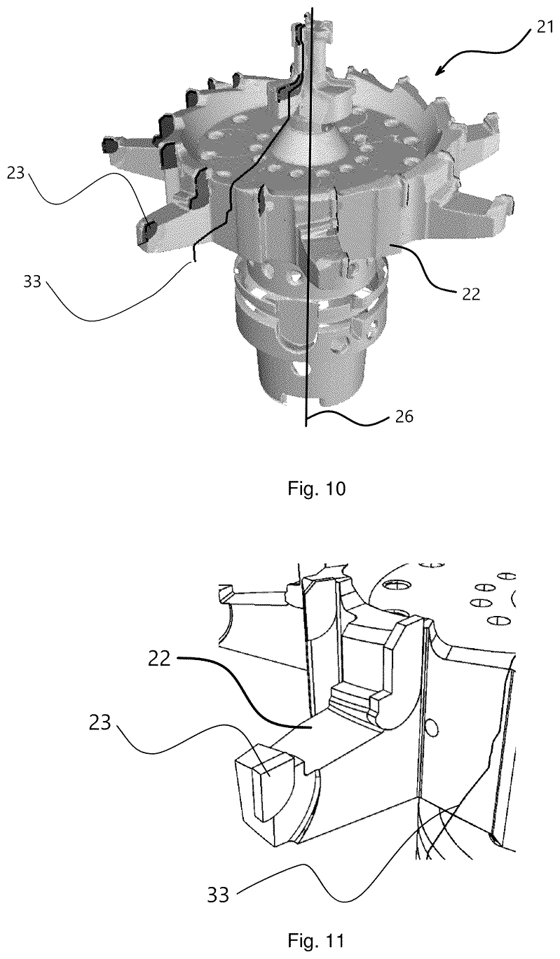

FIGS. 9 to 13 show a second example of a cutting tool 21 machined by the method according to the invention. FIGS. 9 and 10 show the cutting tool 21 before machining. FIG. 9 corresponds to a representation of CAD data of the cutting tool 21 specified by the design of the cutting tool using CAD. FIG. 10 corresponds to a representation of data determined using a surface scanner. The cutting tool 21 comprises a cutting tool body 22 on which a plurality of cutting inserts 23 are arranged. The cutting tool is a rotary tool which is rotated at its point of use about a geometric cutting tool rotation axis 26. In contrast to the first embodiment of a cutting tool according to FIGS. 1 to 8, in the cutting tool 21 according to the second embodiment all cutting inserts 23 are arranged on the cutting tool body 22 in the same axial position relative to the cutting tool axis of rotation 26 and with the same alignment relative to the cutting tool axis of rotation 26.

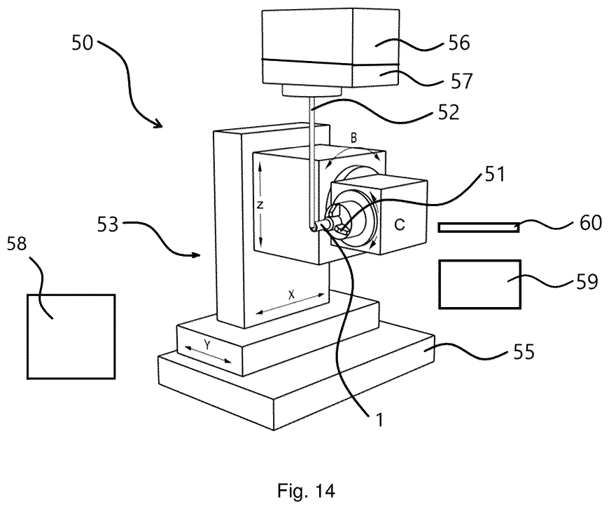

For each cutting insert 23 arranged on the cutting tool body 22, criteria for the course and position of a cutting edge 30 of the cutting insert 23 with respect to the cutting tool axis of rotation 26 of the cutting tool are specified as cutting edge target data. This specified cutting edge 30 is shown in FIG. 13. The specified cutting edge 30 defines a first cutting edge boundary surface 31 and a second cutting edge boundary surface 32. An outer geometry 33 of the cutting tool 21 is specified by the course and position of the cutting edges 30 of all cutting inserts 23 of the cutting tool 21. This outer geometry 33 is marked by a line in FIGS. 9 and 10.

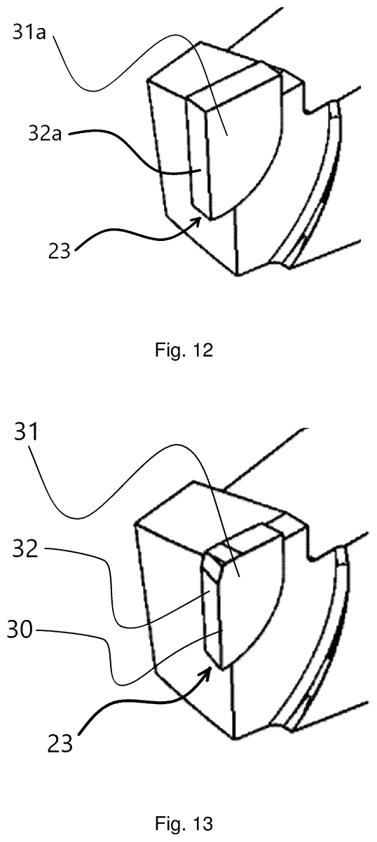

To carry out the method, the cutting edge boundary surfaces 31a, 32a of the cutting inserts 23 are determined from the three-dimensional cutting tool surface of the CAD data according to FIG. 9 or the data determined with a surface scanner according to FIG. 10, and real cutting edge data are derived therefrom. These are compared with specified cutting edge target data. FIGS. 11 and 12 show the two cutting edge boundary surfaces 31a and 32a as exemplified by a cutting insert 23. From the comparison with the specifications for the cutting edge 30, the first cutting edge boundary surface 31 and the second cutting edge boundary surface 32, it can be seen that material removal must take place and to what extent. On the basis of the data thus determined, a machining device can be controlled so that the appropriate material is removed and the cutting 30 meets the specifications shown in FIG. 13, while avoiding a collision of the cutting tool with the material removal device. In this case, the geometry and dimensions of the cutting tool and the material removal device are taken into account. The movement path is defined in such a way that, during a relative movement of the cutting tool and the material removal device, they do not come so close that they touch each other in an unwanted way.

The determination of the position and alignment of the cutting edge boundary surfaces 31a, 32a from the three-dimensional cutting tool surface is carried out in a manner corresponding to the first embodiment, as shown in FIGS. 1 to 8.

FIG. 14 shows a machining device 50 for carrying out the method. The machining device is a laser processing device. It comprises a fixing device 51 which receives and fixes a cutting tool 1, a movement device 53 which moves the cutting tool 1 arranged in the fixing device relative to a device base 55, a laser 56 which generates a laser beam 52, and a laser beam deflecting device 57 which guides the laser beam 5 2. The movement device 53 has, in the present case, three linear axes X, Y, Z and two rotational axes B and C. The rotational axis C causes the cutting tool 1, which is arranged in the workpiece fixing device 51, to rotate about a geometric cutting tool axis of rotation which passes through the cutting tool. The laser beam deflector 57 moves and guides the laser beam 52 in three different directions in space. In the process, the laser beam 52 is moved along a laser path, not shown in FIG. 14, relative to the cutting tool 1. A control device 58 controls the fixing device 51, the movement device 53 and the laser beam deflecting device 57 to carry out the process of machining the workpiece.

The machining device 50 is also provided with a surface scanner 59 which detects the surface of the cutting tool 1 located in the fixing device 51 and stores the determined three-dimensional cutting tool surface. This three-dimensional cutting tool surface is output to the control device 58, which uses it to determine the cutting edge boundary surfaces of the cutting inserts, compares them with specifications for the cutting edges, determines the material to be removed from them and controls the laser beam in order to remove this material from the cutting inserts of the cutting tool 1 in a targeted manner.

For control and testing purposes, the maching device is also provided with a coordinate measuring device 60 which detects the surface of the cutting tool 1 arranged in the fixing device at individual measuring points and assigns coordinates to a coordinate system. It is then checked whether these detected coordinates lie on the specified cutting edge boundary surface. If this is not the case, the cutting edge boundary surface is corrected so that the coordinates of the measuring points lie on the adapted cutting edge boundary surface. The coordinate measuring device 60 is controlled and moved in such a way that a collision between the cutting tool and the coordinate measuring device is avoided. A relative movement between the cutting tool 1 and the coordinate measuring device is carried out with the movement device 53.

Any of the features of the invention, individually or in any combination, may be essential to the invention.

### REFERENCE NUMBERS

1 Cutting tool
2 Cutting tool body
3 First cutting insert
4 Second cutting insert
5 Third cutting insert
6 Cutting tool axis of rotation
7 Shaft
8 End
9 Face
10 Cutting edge
11 First surface defining the cutting edge after machining
11a First surface defining the cutting edge before machining
12 Second cutting edge boundary surface after machining
12a Second surface defining the cutting edge before machining
13 Outer geometry of cutting tool
14 Partial surface
15 Movement path of a cutting tool
16 Measuring point
17 Three-dimensional tool surface determined from CAD data
18 Three-dimensional surface of cutting tool determined by surface scanner
21 Cutting tool
22 Cutting tool body
23 Cutting insert
26 Cutting tool axis of rotation
30 Cutting edge
31 First cutting edge surface after machining
31a First surface before machining
32 Second surface after machining
32a Second surface before machining
33 Cutting tool outer geometry
50 Machining device
51 Fixing device
52 Laser beam
53 Movement device
55 Tool base
56 Laser
57 Laser beam deflector
58 Control unit
59 Surface scanner
60 Coordinate measuring device

1. A method for machining a cutting tool (1, 21) which comprises a cutting tool body (2, 22) and at least one cutting insert (3, 4, 5, 23) with at least one cutting edge (10, 30) attached to the cutting tool body (2, 22), whereby the machining is carried out by a machining device (50) which comprises
a fixing device (51) which receives and fixes the cutting tool (1, 21),
a material removal device (56) which removes material on the cutting insert (3, 4, 5, 23), and
a movement device (53), wherein the movement device (53) moves the cutting tool (1, 21) received in the fixing device (51) and the material removal device (56) relative to each other for targeted material removal,
comprising the following method steps
a) specifying cutting edge target data for the cutting edge (10, 30), whereby the cutting edge target data comprises at least one property from the following set: {cutting edge position relative to a cutting tool based coordinate system, cutting edge geometry, cutting edge contour relative to the cutting edge based coordinate system},
b) specifying geometric material removal device data, including the shape and size of the material removal device (56),
c) fixing the cutting tool (1, 21) in the fixing device (51),
d) defining a three-dimensional surface of the cutting tool (1, 21) arranged in the fixing device (51) at least in those portions of the cutting tool (1, 21) that comprise the cutting insert (3, 4, 5, 23), whereby this surface is defined as a three-dimensional cutting tool surface (17, 18)
e) determining those subregions of the three-dimensional cutting tool surface (17, 18) that form a surface of the cutting insert (3, 4, 5, 23) and are located adjacent to the cutting edge (10, 30) of the cutting insert (3, 4, 5, 23), whereby these subregions are defined as cutting edge boundary surfaces (11a, 12a, 31a, 32a)
f) determining cutting edge real data from the cutting edge boundary surfaces (11a, 12a, 31a, 32a), whereby the cutting edge real data includes at least the property contained in the cutting edge target data,
g) comparing the cutting edge real data with the cutting edge target data,
h) if the deviation between the cutting edge real data and the cutting edge target data is greater than a predetermined tolerance:
i) determining a movement path (15) of the movement device (53) from the predefined material removal device data and the difference between the cutting edge real data and the cutting edge target data, such that, in the event of a relative movement of the cutting tool (1, 21) and the material removal device (56) and simultaneous material removal at the cutting tool (1, 21) with the material removal device (56), the cutting edge (10, 30) is formed with the cutting edge target data within the specified tolerance and a collision between the cutting tool (1, 21) and the material removal device (56) is prevented,
j) controlling the material removal device (56) and the movement device (53) on the basis of the determined movement path and carrying out the associated relative movement with simultaneous removal of material at the cutting insert (3, 4, 5, 23) with the material removal device (56).

2. The method according to claim 1, wherein the cutting tool (1, 21) is a rotary cutting tool which is rotated about a geometric cutting tool axis of rotation (6, 26) during its use.

3. The method according to claim 2, wherein the alignment of the cutting edge boundary surfaces (11a, 12a, 31a, 32a) relative to the geometric cutting tool axis of rotation (6, 26) is determined.

4. The method according to claim 2, wherein the position of the cutting edge boundary surfaces (11a, 12a, 31a, 32a) relative to the geometric cutting tool axis of rotation (6, 26) is determined.

5. The method according to one of the claim 1, wherein a plurality of measuring points (16) are determined on at least one cutting edge boundary surface (11a, 12a, 31a, 32a), and wherein, the coordinates corresponding to the cutting edge boundary surface (11a, 21a, 31a, 32a) with respect to a predetermined coordinate system are recorded at these measuring points (16) by a coordinate measuring device (60) in the case of the cutting tool (1) arranged in the fixing device (51).

6. The method according to claim 5, wherein the cutting edge boundary surface (11a, 12a, 31a, 32a) is adapted taking into account the coordinates of the measuring points, which are determined by the coordinate measuring device (60), in such a way that the coordinates of the measuring points determined lie on the adapted cutting edge boundary surface (11a, 12a, 31a, 32a).

7. The method according to claim 5, wherein the scanning data determined during the scanning is used to check whether the cutting edge boundary surfaces (11a, 12a, 31a, 32a) are curved or flat.

8. The method according to claim 5, wherein the coordinate measuring device (60) is moved relative to the cutting tool (1, 21) with the movement device (53) in such a way that the coordinates of the measuring points (16) are detected and the relative movement is carried out without collisions between the cutting tool (1, 21) and the coordinate measuring device (60).

9. The method according to one of the preceding claim 1, wherein the movement path (15) extends in a region that extends beyond an edge of at least one cutting edge boundary surface (11a, 12a, 31a, 32a).

10. The method according to one of the claim 1, wherein a starting point and an end point of the material removal at the cutting edge boundary surface (11a, 12a, 31a, 32a) are determined with the aid of the cutting edge boundary surfaces (11a, 12a, 31a, 32a).

11. The method according to one of the preceding claim 1, wherein the material removal device comprises a laser (56) and the material removal is carried out by the laser (56).

12. The method according to claim 10, wherein a laser beam (52) of the laser (56) is moved relative to the cutting tool (1, 21) by an optical laser beam deflection device (57) and wherein this movement is superimposed on the movement of the cutting tool (1, 21) produced by the movement device (53).

13. The method according to claim 1, wherein the material removal device is provided with an abrasive wheel and the material removal is carried out with the abrasive wheel.

14. The method according to claim 1, wherein the material removal is carried out by electrical discharge machining (EDM).

15. The method according to claim 1, wherein the cutting insert (3, 4, 5, 23) comprises an ultra-hard material such as polycrystalline diamond (PCD), cubic boron nitride (CBN), diamond from chemical vapor deposition (CVD), monocrystalline diamond or ceramic.

16. The method according to claim 1, wherein the three-dimensional cutting tool surface (17) is determined from predetermined CAD data of the cutting tool (1, 21).

17. The method according to claim 1, wherein the three-dimensional cutting tool surface (18) is generated by a surface scanner (59) which scans the surface of the cutting tool.

18. The method according to claim 1, wherein a grid of partial surfaces (14) is laid over the three-dimensional cutting tool surface (17, 18), wherein the alignment relative to the geometric cutting tool axis of rotation (6, 26) is determined for each partial surface (14), and wherein the cutting edge boundary surfaces (11a, 12a, 31a, 32a) are determined.

19. The method according to claim 18, wherein the partial surfaces (14) are triangles.

20. The method according to claim 18, wherein the alignment of each two adjacent partial surfaces (14) is compared with each other and wherein the cutting edge boundary surfaces (11a, 12a, 31a, 32a) are determined therefrom.

21. The method according to claim 1, wherein the collision-free movement path is determined by means of a Minkowski addition.

22. A machining device for machining a cutting tool (1, 21) which comprises a cutting tool body (2, 22) and at least one cutting insert (3, 4, 5, 23) with at least one cutting edge (10, 30) attached to the cutting tool body (2, 22), wherein the machining device (50)
has a fixing device (51) which receives and fixes the cutting tool (1, 21),
a material removal device (56) which removes material on the surface of the cutting tool (1, 21) and
a movement device (53), which moves the cutting tool (1, 21) received in the fixing device (51) and the material removal device (56) relative to each other for targeted material removal,
wherein the machining device (50) comprises a control device (58) which controls the fixing device (51), the movement device (53) and the material removal device (56) in such a way that they carry out the method according to claim 1 on the cutting tool (1, 21).

23. The machining device according to claim 22, wherein the material removal device is provided with a laser (56) which removes material on the cutting edge boundary surfaces (11a, 12a, 31a, 32a) by laser machining of the cutting edge boundary surfaces (11a, 12a, 31a, 32a).

24. The machining device according to claim 22, wherein the material removal device is provided with at least one grinding wheel which removes material on the cutting edge boundary surfaces by chip removal by grinding.

25. The machining device according to claim 22, wherein the material removal device is adapted to remove material at the cutting edge boundary surfaces by electric discharge machining (EDM).

26. The machining device according to claim 22, further comprising a surface scanner (59) which detects the surface of the cutting tool (1, 21) at least in those parts of the cutting tool (1, 21) which comprise the cutting insert (3, 4, 5, 23).

27. The machining device according to claim 22, further comprising a coordinate measuring device (60) which detects the coordinates of the surface of the cutting tool with respect to a predetermined coordinate system at specific measuring points (16) on the surface of the cutting insert (3, 4, 5, 23).
